(19) United States
(12) Patent Application Publication
(10) Pub. No.: US 2011/0079965 A1
(43) Pub. Date: Apr. 7, 2011

(54) SEAL, FURNACE PART PROVIDED WITH SUCH A SEAL, AND FURNACE INCLUDING SUCH A SEAL

(75) Inventors: Lionel Dromain, Crepy En Valois (FR); Jean Ferrand, Crepy En Valois (FR); Yann Simonet, Compiegne (FR)

(73) Assignee: FEDERAL MOGUL SYSTEMS PROTECTION, Crepy En Valois (FR)

(21) Appl. No.: 12/995,276

(22) PCT Filed: May 29, 2009
(86) PCT No.: PCT/FR2009/000631

§ 371 Date: Nov. 30, 2010

(30) Foreign Application Priority Data
Jun. 2, 2008 (FR) 0853615

(51) Int. Cl. F16J 15/02

(52) U.S. Cl. 277/630

(57) ABSTRACT

The invention relates to a seal (10) including a casing, cross-sectionally defining a bulb (12) capable of changing shape to ensure sealing, and a lip (16) extending away from the bulb (12). An element (20) having a degree of elasticity perpendicularly to the cross-section is received in the lip (16). A furnace includes a muffle (2) and a front surface (4) defining a generally rectangular chute (6) therebetween. The seal (10) is mounted in the chute (6).

The present invention concerns a seal, an oven part provided with such a seal, and an oven including such a seal.

In order to ensure sealed closure of a oven by its door (which is necessary in the case of pyrolysis ovens in particular in order to prevent the emission of smoke that is given off when burning grease), there is conventionally used a seal mounted on the front face of the oven or on the door and disposed between these two elements in the closed position of the door.

The seal is traditionally retained on the element of the oven that receives it by means of clips situated at various points along the length of the seal. The seal is for example a lip seal with a lip which comprises a rigid part.

A solution of this type is described in patent application WO 97/36137, for example.

To simplify these means for mounting the seal on the oven and to facilitate possible demounting of the seal (for example with a view to its replacement), the invention proposes a seal comprising an envelope defining in section a bulb adapted to be deformed to provide the seal and a lip extending from the bulb, characterized in that an element having elasticity perpendicular to said section is received in the lip.

The elasticity perpendicular to the section, i.e. generally along the general direction of the seal, makes it possible to press the lip onto the device that receives the seal and consequently to ensure that it is mounted in contact with that device.

The seal extends along a closed curve, for example, as is the case with seals intended to be mounted around the cavity of the oven to provide sealed closure of the oven by the door.

The abovementioned element is for example a spring that extends in the general direction of the seal.

The spring may then be under tension and also define a closed curve along its length, in which case the spring may grip around the device on which the seal is mounted and thus fix the seal.

The spring is in practice received in a secondary bulb situated at the edge of the lip, for example.

In embodiments described hereinafter, the envelope may be produced in woven textile and the bulb may furthermore receive a knitted metal cylinder.

The invention also proposes an oven part (for example a door) comprising such a seal, wherein the element grips the oven part in order notably to fix it thereto.

Thus the invention further proposes an oven including a muffle and a front face defining between them a trough of rectangular general shape, characterized in that a seal as described above is mounted in the trough. Thus the trough is used to fix the seal.

It is for example the lip of the seal that is inserted in the trough. The elastic element can thus grip around the muffle.

This element is for example pressed by elasticity at the edge of a reentrant rim of the muffle.

The trough may equally be rounded between two trough parts defining said rectangular general shape, which makes it possible to avoid the formation of sharp corners with which the elastic element would have to come into contact.

Other features and advantages of the invention will become apparent in the light of the following description given with reference to the appended drawings in which:

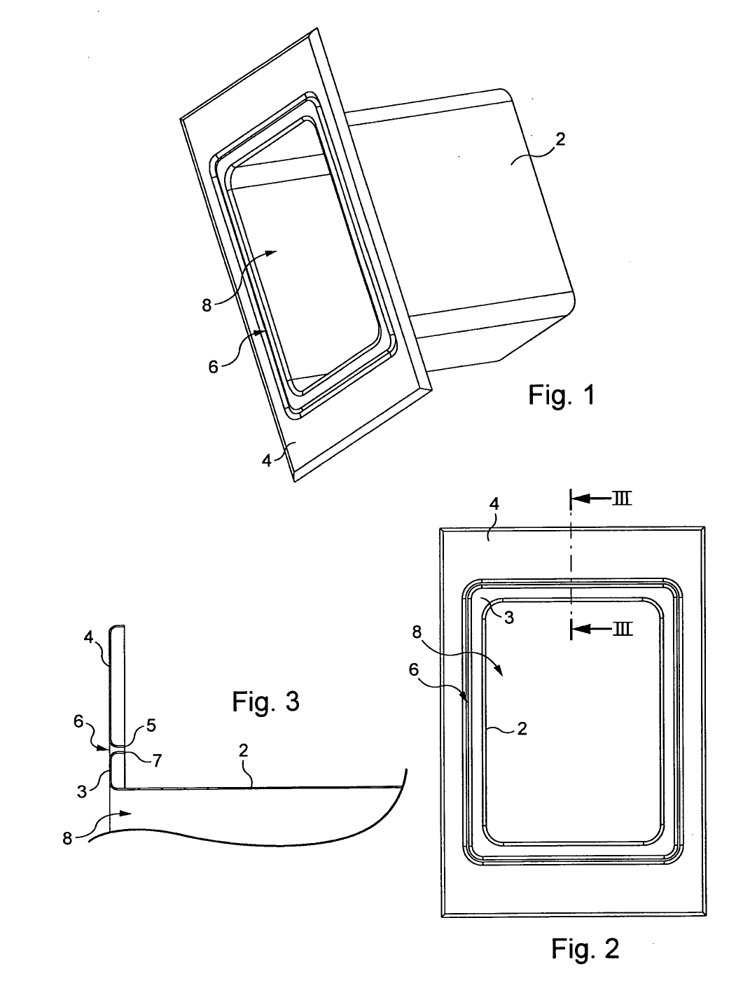

FIG. 1 represents a perspective view of part of an oven intended to be equipped with the seal of the invention;

FIG. 2 is a view of the front face of the oven from FIG. 1;

FIG. 3 is a view of the oven from FIG. 2 in section taken along the line III-III;

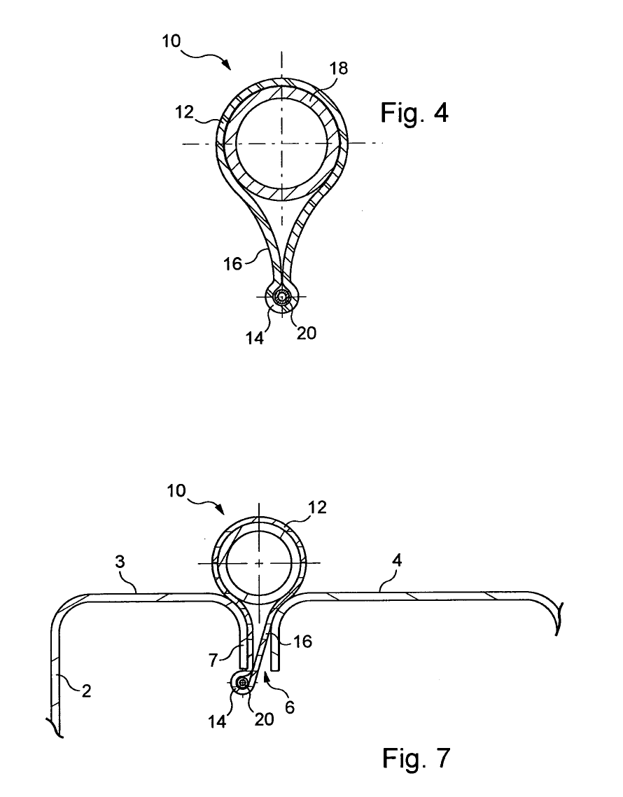

FIG. 4 is a view in section of a seal produced in accordance with the teachings of the invention;

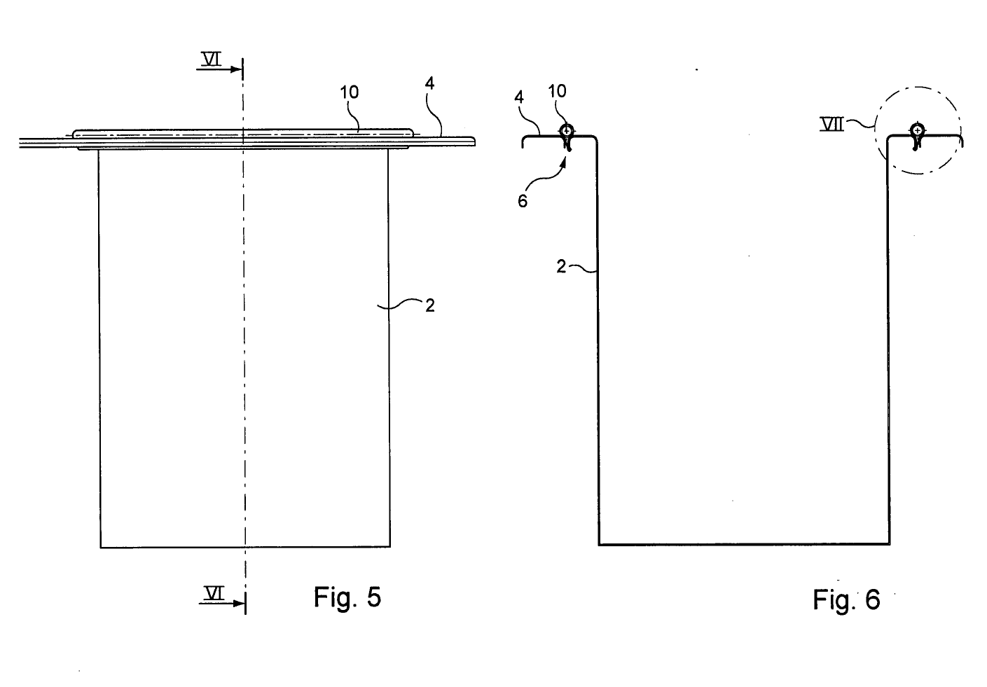

FIG. 5 represents the oven portion from FIG. 1 equipped with the seal from FIG. 4;

FIG. 6 is a section on the plane VI-VI in FIG. 5;

FIG. 7 represents the detail VII defined in FIG. 6.

FIGS. 1, 2 and 3 represent the muffle 2 and the front face 4 of an oven.

As clearly visible in FIG. 1, the muffle 2 is of parallelepiped general shape and defines a cavity 8 intended to receive food to be cooked. The muffle 2 is therefore designed to withstand the high temperatures to which it is subjected and is thus generally produced in the form of a part distinct from the rest of the oven (and notably from the front face 4), which also limits the transmission of heat from the muffle 2 to the other parts of the oven.

There is therefore generally a gap 6, referred to as a trough, between the muffle 2 and the front face 4, which here extends around the whole of the perimeter of the muffle 2 and therefore has a rectangular general shape. However, the transition between two sides of the rectangle defined by the trough 6 is always rounded in order to prevent sharp corners.

The muffle 2 further defines in its portion intended to be placed at the front of the oven a ring 3 extending the walls of the muffle 2 defining the cavity 8 and lying in a plane perpendicular to those walls (and thus, once mounted, in the plane of the front face 4).

As clearly visible in FIG. 3, the front face 4 and the ring 3 are each extended at the level of the trough 6 by a rim 5, 7 that extends toward the interior of the oven, i.e. parallel to the walls of the muffle 2 defining the cavity 8 and on the same side as the latter relative to the front face 4. The trough 6 is therefore defined between the rim 5 of the front face 4 and the rim 7 of the ring 3 of the muffle 2.

FIG. 4 represents a seal 10 adapted to be mounted in the trough 6 that has just been described.

The seal 10 comprises an envelope (or sheath), here of woven textile, which defines in section (i.e. as seen in FIG. 4) a bulb 12 (called the main bulb) with a section of circular general shape from which extends a lip 16 (sometimes referred to as a flange) the edge 14 of which receives a spring 20 (this edge also defines a generally cylindrical space of smaller diameter than the bulb 12 and for this reason sometimes called the secondary bulb).

The cylindrical shape of the bulb 12 and its elasticity in the section plane of FIG. 4 adapted to effect the seal provided by the seal are made possible here by the use of a metal knitted cylinder 18 received inside the bulb 12 of the envelope.

Here the spring 20 is a metal coil spring and thus has an elasticity in its lengthwise direction, i.e. perpendicularly to the section plane of FIG. 4.

As indicated above, the seal 10 is intended to be mounted in the trough 6 and to this end has a closed general shape the length of which is equal to the perimeter of the trough 6.

For its part the spring 20 has an unstressed length that is less than the perimeter of the trough 6 and extends continuously over the whole length of the seal 10 (for example because it is butt-jointed) so that it is mounted under tension in the seal 10 (which does cause problems given the relative elasticity of the braided textile envelope).

The seal 10 is obtained for example by braiding the envelope over the metal knitted cylinder 18 and then inserting the spring 20 (as yet not closed on itself) into the lip 16, butt-jointing the spring 20 (for example by inserting the turns at one end into the turns at the other end) and thus the seal itself, to obtain the closed shape, and then sewing the two ends of the seal 10 together (forming a vignette).

FIGS. 5 to 7 represent the seal 10 mounted in the trough 6 formed as already indicated between the front face 4 and the muffle 2 of the oven.

As clearly visible in FIG. 7, the lip 16 of the seal 10 is inserted in the trough 6 and has a length slightly greater than the rim 7 of the ring 3 of the muffle 2 so that its edge 14 is level with the edge of this rim 7.

The spring 20, which extends over the whole periphery of the trough 6 and is under tension, as already indicated, tends to grip the muffle 2 (fitted sheet effect) with the result that the edge 14 of the lip 16 is pressed into contact with the edge of the rim 7 of the ring 3 of the muffle 2.

The seal 10 is therefore retained in the trough 6 with the bulb 12 of the seal 10 positioned on the front face 4 of the oven in order to provide the seal when the door of the oven (not shown) comes into contact with the front face 4.

Note further that, as clearly visible in FIG. 7, the proposed solution makes it possible to press the bulb 12 against the ring 3 and the front face 4 over the whole of the periphery of the trough 6, which makes it possible to prevent circulation of air in the trough and ensure good thermal isolation there.

It is clear that the proposed solution makes mounting the seal 10 on the oven particularly simple. Using the trough 6 for mounting further avoids providing locations dedicated to mounting the seal and thus enhances the freedom of design in respect of the oven.

The seal 10 is mounted in the trough 6 manually, for example, starting by introducing the vignette, and then little by little the whole of the seal, the entry of the spring 20 into the trough 6 over the whole of the perimeter thereof being made possible in particular by the elasticity of the spring 20.

The example that has just been described is merely one possible embodiment of the invention, which is not limited to it. In particular, although the embodiment described above provides for mounting the seal on the front face of an oven, it could be mounted for example on an oven door having a shape adapted to be gripped by the spring present in the lip of the seal.

1. Seal (10) comprising an envelope section a bulb (12) adapted to be deformed to provide the seal and a lip (16) extending from the bulb (12),
characterized in that an element (20) having elasticity perpendicular to said section is received in the lip.

2. Seal according to claim 1, extending along a closed curve.

3. Seal according to claim 2, wherein said element is a spring (20) that extends in the general direction of the seal (10).

4. Seal according to claim 3, wherein the spring (20) is under tension and defines in its lengthwise direction a closed curve.

5. Seal according to claim 3, wherein the spring is received in a secondary bulb situated at the edge (14) of the lip (16).

6. Seal according to claim 1, wherein the envelope is produced in woven textile.

7. Seal according to claim 1, wherein the bulb (12) receives a knitted metal cylinder (18).

8. Oven part comprising a seal (10) according to claim 1, in which said element grips around said part.

9. Oven comprising a muffle (2) and a front face (4) defining between them a trough (6) of rectangular general shape, wherein a seal (10) according to claim 1 is mounted in the trough (6).

10. Oven according to claim 9, wherein the lip (16) is inserted in the trough (6).

11. Oven according to claim 9, wherein said element (20) is pressed by elasticity onto the edge of a re-entrant rim (7) of the muffle (2).

12. Oven according to claim 9, wherein the trough (6) is rounded between two trough parts defining said rectangular general shape.

13. Seal according to claim 1, wherein said element is a spring (20) that extends in the general direction of the seal (10).

14. Seal according to claim 4, wherein the spring is received in a secondary bulb situated at the edge (14) of the lip (16).

15. Oven according to claim 10, wherein said element (20) is pressed by elasticity onto the edge of a re-entrant rim (7) of the muffle (2).
